(19) United States
(12) Patent Application Publication
(10) Pub. No.: US 2013/0167198 A1
(43) Pub. Date: Jun. 27, 2013

(54) Protocol for sequential rights transactions

(71) Applicants: Lawrence MacLennan, Londonderry, NH (US); Jason Boyer, Waltham, MA (US); Robert Mathews, Jamaica Plain, MA (US)

(72) Inventors: Lawrence MacLennan, Londonderry, NH (US); Jason Boyer, Waltham, MA (US); Robert Mathews, Jamaica Plain, MA (US)

(21) Appl. No.: 10/463,226

(22) Filed: Jun. 16, 2003

(51) Int. Cl. H04L 29/06

(52) U.S. Cl. CPC H04L 63/08
USPC 726/4

(57) ABSTRACT

Methods and apparatus, including computer program products, implement techniques for delivering a rights object granting one or more rights to a media object. The rights object has an associated return address, and the return address is usable to initiate a subsequent rights transaction relating to the rights granted by the rights object.

### BACKGROUND

The present invention relates to the sequential rights transactions related to media object rights.

A media object is a collection of digital data. Data in a media object can represent content, such as text, graphics, audio, video, electronic documents, computer program instructions and/or other information, and other data or information stored in an electronic file. When media objects are distributed, e.g. sold or loaned to consumers, media object content can be protected by a digital rights management (“DRM”) system.

In a typical DRM system, a media object with protected content is associated with a set of rights. Each right in the set specifies one or more permitted actions that can be authorized using the right. Optionally, the set of rights can specify conditions on performing the permitted actions. For example, an electronic document can be associated with a print right that can authorize printing. Optionally, conditions on the print right can specify, e.g., a limited time period, a portion of the content or a maximum number of pages for printing. The media object rights can be expressed using, e.g., rights languages such as Extensible rights Markup Language (“XrML”) or Open Digital Rights Language (“ODRL”).

DRM systems define protocols for distributing rights to media objects. A rights holder of the rights to a media object requests the rights using a client computer. The rights request is transmitted to a media object server implementing the DRM system. In a typical DRM system the rights holder can also obtain a media object application program and install it on the client computer. If the request for the rights can be fulfilled, the media object server generates a rights object specifying the rights to the media object being granted, and transmits the rights object to the client. The rights holder can access the granted rights to the media object using the media object application installed on the client. If the rights specified in the rights object have a limited rights duration, the rights object can be disabled at the expiration of the rights duration preventing future access to the expired rights.

### SUMMARY OF THE INVENTION

In general, in one aspect, the invention provides methods and apparatus, including computer program products, for delivering a rights object granting one or more rights to a media object, the rights object having an associated return address, the return address being usable to initiate a subsequent rights transaction relating to the rights.

Advantageous implementations of the invention include one or more of the following features. Delivering a rights object can include delivering a rights object including a transaction identifier associated with the rights object, where the transaction identifier can be associated with the return address. Delivering a rights object can also include delivering a rights object including a rights duration for one or more of the rights. The return address is usable to initiate a subsequent rights transaction to relinquish, replace or modify one or more of the rights. The return address can be a URL or an IP address. The method further includes, receiving a subsequent rights transaction request to relinquish, replace, or modify one or more rights to a media object, the subsequent transaction request originating from a client, authenticating the subsequent transaction request, and transmitting a response to the client for the subsequent rights transaction request. If the subsequent rights transaction request is a valid relinquish rights request, an acknowledgement is transmitted to the client. If the subsequent rights transaction request is a valid replace rights request, a replacement rights object is transmitted to the client. If the subsequent rights transaction request is a valid modify rights request, a modifying rights object is transmitted to the client. If the subsequent rights transaction request is a relinquish rights request, authenticating the subsequent rights transaction request includes determining whether the subsequent rights transaction request has been received during a time period defined by a rights duration associated with the rights. If the subsequent rights transaction request is a replace rights request, authenticating the subsequent rights transaction request includes determining whether the replace rights request can be granted. If the subsequent rights transaction request is a modify rights request, authenticating the subsequent rights transaction request includes determining whether the modify rights request can be granted. Authenticating the subsequent rights transaction request can also include determining whether there is a rights fulfillment transaction associated with the request. Receiving a subsequent rights transaction request for the rights includes receiving a subsequent rights transaction request having an associated transaction identifier. The transaction identifier can be used to identify a rights fulfillment transaction or a media object associated with the rights. The method further includes, determining whether the rights are outstanding, and if the rights are outstanding, generating a NONCE and transmitting the NONCE to the client. The method includes, receiving a signed NONCE and a public key certificate from the client, the signed NONCE being signed using the client's private key, and determining the validity of the subsequent rights transaction request using the signed NONCE and the public key certificate.

In general, in another aspect, the invention provides methods and apparatus, including computer program products, for initiating a rights fulfillment request for one or more rights to a media object, and receiving a rights object granting one or more rights to the media object, the rights object having an associated return address, the return address being usable to initiate a subsequent rights transaction relating to the rights.

Advantageous implementations of the invention include one or more of the following features. Receiving a rights object can include receiving a transaction identifier associated with the rights. The transaction identifier can be associated with the return address. The return address is usable to initiate a subsequent rights transaction to relinquish, replace, or modify one or more of the rights. Receiving a rights object includes receiving a rights object including a rights duration for one or more of the rights. Initiating a rights fulfillment request can include, receiving a NONCE from a server requesting authentication of the request, signing the NONCE using a private key, and transmitting the signed NONCE and the public key certificate to the server requesting authentication. The method includes using the rights object to access the one or more rights to the media object. The method also includes using the return address to initiate a subsequent rights transaction relating to one or more of the rights granted by the rights object. Using the return address can include, using the return address to transmit a subsequent rights transaction request to relinquish one or more of the rights granted by the rights object, and disabling the rights object. Using the return address can also include, using the return address to transmit a transaction identifier associated with the rights object. The method includes responding to authentication requests from a server. The method also includes receiving a NONCE from a server, signing the NONCE using a private key, the private key having an associated public key certificate, and transmitting to the server, the signed NONCE and the public key certificate. The method includes transmitting to a server a subsequent rights transaction request, and receiving a response for the subsequent rights transaction request. The subsequent rights transaction request includes a relinquish rights request, a replace rights request, or a modify rights request, and the subsequent transaction request relates to one or more of the rights granted by the rights object. If the subsequent rights transaction request is a relinquish rights request, the method includes receiving an acknowledgement for the request and disabling the rights object. If the subsequent rights transaction request is a replace rights request, the method includes receiving a replacement rights object and replacing the rights object with the replacement rights object. If the subsequent rights transaction request is a modify rights request, the method includes receiving a modifying rights object and modifying the rights object with the modifying rights object. The method also includes, re-transmitting to the server the subsequent rights transaction request, if a response for the subsequent rights transaction request is not received from the server.

In general, in another aspect, the invention provides a rights object tangibly embodied in a computer readable medium. The rights object includes, a rights descriptor specifying one or more rights to a media object, a return address usable to initiate a subsequent rights transaction relating to one or more of the rights, and a transaction identifier identifying a rights transaction granting the rights. The rights object can also include a rights duration associated with the rights.

The invention can be implemented to realize one or more of the following advantages. A user can initiate a subsequent rights transaction relating to one or more of the media object rights granted by a rights object. The rights object granting the rights to the media object contains a return address that can be used by the client for a subsequent rights transaction relating to the rights. The subsequent rights transaction can include relinquishing the rights, replacing the rights with new replacement rights, or modifying the rights. The subsequent rights transaction can be performed in a secure manner to protect and/or prevent security attacks on a server processing the transaction. The user can relinquish the rights to a media object before a rights duration associated with the rights has expired. If there is a limited inventory of rights and if the rights granted to the client for an original rights duration are relinquished before the expiration of the original rights duration, the media object server can grant the rights to another user before the original rights duration has expired. One implementation of the invention provides all of the above advantages.

The details of one or more implementations of the invention are set forth in the accompanying drawings and the description below. Further features, aspects, and advantages of the invention will become apparent from the description, the drawings, and the claims.

### BRIEF DESCRIPTION OF THE DRAWINGS

FIG. 1 is a block diagram illustrating the transactions between a media object server and a media object client according to one aspect of the invention.

FIG. 2 illustrates the components of an exemplary rights object transmitted by the media object server.

FIG. 3 is a flow diagram illustrating a method of operation of the media object server responding to a rights request.

FIG. 4 is a flow diagram illustrating a method of operation of the client requesting the rights to a media object.

FIG. 5 is a flow diagram illustrating a method of operation of a rights transaction server responding to a subsequent rights transaction request.

FIG. 6 is a flow diagram illustrating a method for authenticating the subsequent rights transaction request.

FIG. 7A illustrates a method of processing the relinquish rights request at the client.

FIG. 7B illustrates a method of processing the replace rights request at the client.

FIG. 7C illustrates a method of processing the modify rights request at the client.

FIG. 8A illustrates a method for disabling the rights object after the server acknowledges the relinquish rights request.

FIG. 8B illustrates a method for replacing the rights object after a replacement rights object is received from the server.

FIG. 8C illustrates a method for modifying the rights object after a modify rights object is received from the server.

Like reference numbers and designations in the various drawings indicate like elements.

### DETAILED DESCRIPTION

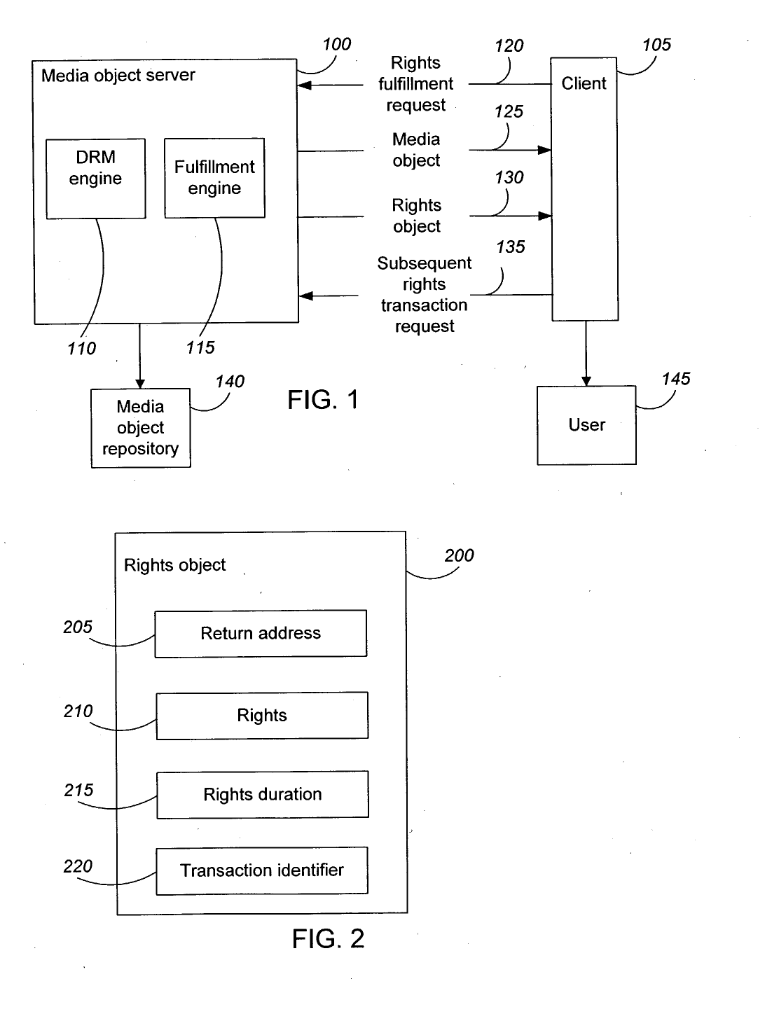

FIG. 1 is a block diagram illustrating transactions relating to the exchange of rights to a media object between a media object server 100 and a media object client 105 according to one aspect of the invention. A media object does not necessarily correspond to a file. A media object may be stored in a portion of a file that holds other media objects, in a single file dedicated to the media object in question, or in multiple coordinated files. In one implementation a media object is an electronic book. Rights to a media object can include the right to display, print, copy, sell, lend, give and/or modify the media object, and the right to modify the rights when transferring the media object. The media object server 100 manages the rights for the media objects in an associated media object repository 140. The media object server 100 can have more than one associated media object repository 140. In one implementation, the media object server 100 includes a DRM engine 110, and a fulfillment engine 115. The fulfillment engine 115 manages transactions between the media object server 100 and the client 105. The fulfillment engine 115 uses the DRM engine 110 to authenticate the validity of the client 105 and to generate rights objects in response to authenticated requests from the client 105. In addition, the fulfillment engine 115 may perform database tasks such as recording initial order entry records and fulfillment records. The DRM engine 110 or the fulfillment engine 115 may also be responsible for ensuring proper inventory tracking for the media objects and the rights for the media objects.

A user 145 seeking rights to one or more media objects interacts with the media object server 100 through the client 105 to complete transactions for one or more rights to a media object in the media object repository 140. The client 105 can issue a rights fulfillment request 120 to the media object server 100 requesting rights to the media object. The rights fulfillment request can result in a rights transaction between the media object server 100 and the client 105, granting one or more of the requested rights to the client 105. The rights fulfillment request 120 identifies one or more rights to a media object that are being requested by the client 105. The rights fulfillment request 120 can also identify an existing rights transaction in the fulfillment engine database. In response to the rights fulfillment request 120, the media object server 100 transmits a rights object 130 granting one or more of the requested rights to the client 105. The rights granted by rights object can be new rights to the requested media object. Alternatively, the rights object can grant rights intended to replace (i.e., replacement rights) or modify (i.e., modifying rights) rights previously obtained for the media object. The media object server 100 can also transmit the requested media object 125, to the client. In one implementation, transmission of the requested media object 125 is optional if the client 105 indicates it has a copy of the requested media object. For example, the client 105 can have a copy of the requested media object as a result of a previous rights fulfillment request 120. A client 105 obtaining the rights object can use a return address associated with the rights object to issue a subsequent rights transaction request 135 related to the rights. The subsequent rights transaction request 135 can include a request to relinquish the rights, a request to replace the rights, and/or a request to modify the rights. For example, a client 105 obtaining the rights for a limited duration of time, defined by a rights duration associated with the rights, can relinquish the rights before the rights duration expires using a subsequent rights transaction request 135.

FIG. 2 illustrates the structure of an exemplary rights object 200 transmitted by the media object server 100. The rights object 200 includes one or more rights 210 to a media object granted to the client 105. The client 105 is required to use the rights object 200 in order to access the rights 210 to the media object granted by the rights object 200. In one implementation, the rights object 200 is a digital object that includes an electronic signature, and the client 105 is required to validate the electronic signature before allowing access to the rights 210. In an alternative implementation, the user (145, FIG. 1) cannot directly access the rights object 200 and only the client 105 can access the rights object 200. In addition, the rights object 200 can include a rights duration 215 associated with the rights 210. The rights duration 215 specifies a duration of time for which the associated rights are granted to the client. The client 105 cannot use the rights object 200 to access the rights 210 if the rights duration 215 associated with the rights 215 has expired. In one implementation, the client 105 deletes the rights object 200 after the rights duration 215 has expired. The rights object 200 can have an associated return address 205 that is usable by the client 105 to initiate a subsequent rights transaction request related to the rights—for example, relinquish the rights 210. The rights object 200 can also have an associated transaction identifier 220 associated with the rights. The transaction identifier 220 can be used by the media object server 100 to identify a rights transaction associated with the rights. The return address 205 and the transaction identifier 220 can be included in the rights object 220 or supplied separately from the rights object 200. In one implementation, the transaction identifier 220 is included in the return address 205.

The client 105 can generate a subsequent rights transaction request (135, FIG. 1) by using the return address 205 to initiate a subsequent rights transaction relating to the rights 210—for example, to return the rights 210 during the associated rights duration 215. In one implementation, the subsequent rights transaction request includes the transaction identifier 220. The return address 205 identifies a rights transaction server that processes the subsequent rights transaction request 135 issued by the client. The rights transaction server can be the media object server 100 that responded to the rights fulfillment request 120, or it can be a server other than the media object server 100 that is designated to process the subsequent rights transaction request 135. In one implementation, the return address 205 can be a URL identifying the rights transaction server. In another implementation, the return address 205 can be an IP address identifying the rights transaction server.

There can be different rights durations associated with the rights granted by the media object server 100 in response to a rights fulfillment request (120, FIG. 1). For example, the rights fulfillment request 120 can specify different rights durations for the requested rights or some of the requested rights may only be available for rights duration different from the requested rights duration. In one implementation, all the rights 210 in the rights object 200 have the same rights duration 215, and separate rights objects 200 are issued for rights 210 having different rights durations 215. In an alternative implementation, the rights object 200 can include the different durations associated with the rights. In one implementation, a subsequent rights transaction initiated using the return address 205 can relate to only a subset of the rights granted by the rights object 200. For example, the client can use the return address 205 to relinquish a subset of the rights granted by the rights object 200. Alternatively, a subsequent rights transaction initiated using the return address 205 can relate to all of the rights 210 granted by the rights object 200. For example, the client can use the return address 205 to relinquish all of the rights 210 to the media object granted by the rights object 200.

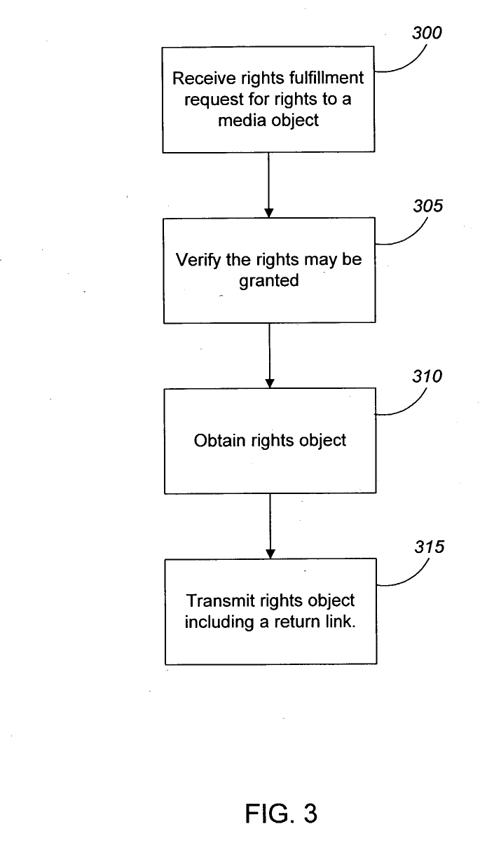

FIG. 3 is a flow diagram illustrating a method of operation of the media object server (100, FIG. 1) responding to the rights fulfillment request (120, FIG. 1). Referring to FIG. 1, the media object server 100 receives the rights fulfillment request 120 for the rights to a media object (step 300). The media object server verifies that the rights fulfillment request 120 may be granted (step 305). In one implementation, the rights specified by the rights fulfillment request 120 may not be available if the media object server 100 is unable to locate the requested media object in the media object repository 140. In another implementation, a right specified by the rights fulfillment request may not be available because there is a limited inventory of rights, and the inventory of requested rights to the media object is currently zero. Referring to FIG. 2, if the rights requested by the rights fulfillment request 120 are available, the media object server 100 obtains a rights object 200 (step 310). In one implementation, the rights object 200 obtained by the media object server 100 includes a return address 205 and a transaction identifier 220. In an alternative implementation, the rights object 200 obtained by the media object server 100 does not include a return address 205 and/or a transaction identifier 220, and the return address 205 and/or the transaction identifier 220 is included in the response by the media object server 100 in addition to the rights object 200. The media object server 100 transmits the rights object 200, the associated return address 205, and the associated transaction identifier 220 (either in or with the rights object 200) to the client (step 315). In one implementation, the media object server 100 can generate the rights object 200 from its associated DRM engine 110. In an alternative implementation, the media object server 100 obtains the rights object 200 from a DRM engine 110.

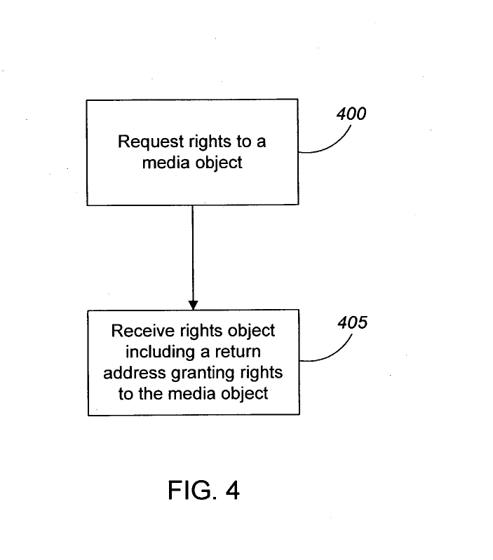

FIG. 4 is a flow diagram illustrating a method of operation of the client (105, FIG. 1), requesting the rights to a media object The client 105 transmits the rights fulfillment request (120, FIG. 1) to the media object server 100 requesting the rights to a media object (step 400). In response to the request, the client receives a rights object (200, FIG. 2), and an associated return address (205, FIG. 2), granting rights to the media object (step 405).

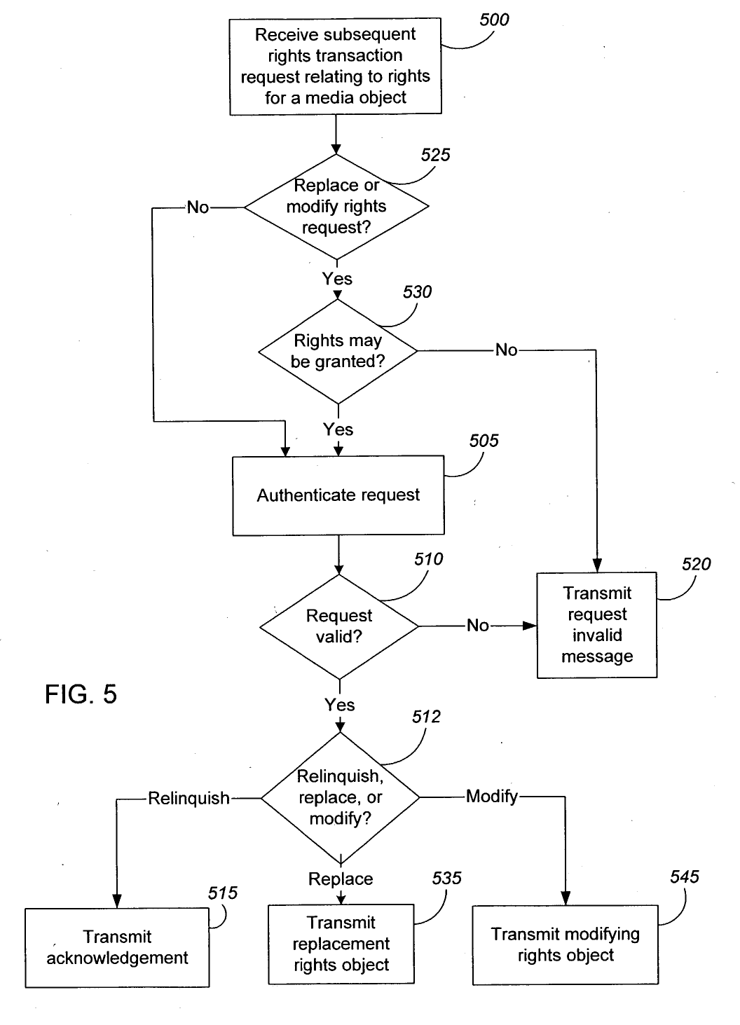

FIG. 5 is a flow diagram illustrating a method of operation of a rights transaction server responding to a subsequent rights transaction request relating to the rights for a media object (135, FIG. 1). In one implementation, the rights transaction server can be the media object server 100. The rights transaction server receives the subsequent rights transaction request 135 for the rights to a media object (step 500). The subsequent rights transaction request 135 includes information required by the rights transaction server to identify the outstanding rights transaction associated with the media object. In one implementation, the return address (205, FIG. 2) and the transaction identifier (220, FIG. 2) are used by the client 105 to build a compound rights transaction request. In another implementation, the transaction identifier 220 is contained in the message sent in the request to the rights transaction server at the return address 205. In an alternative implementation, the message sent in the request to the rights transaction server can specify a subset of the rights granted by the rights object (200, FIG. 2) as the rights to which the subsequent rights transaction request 135 will apply.

If the subsequent rights transaction request 135 relates to modification or replacement of the rights (“yes” branch of decision step 525), the rights transaction server verifies that the replacement or modifying rights may be granted (step 530). For example, the rights transaction server can determine whether the user submitting the subsequent rights transaction request 135 has the right to replace or modify rights relating to the media object. The rights transaction server can also determine whether it is authorized to grant the rights requested in the subsequent rights transaction request 135, or if the server's available inventory of the requested rights is sufficient to allow it to grant the rights. If the replacement or modifying rights cannot be granted (“no” branch of decision step 530), the rights transaction server transmits a message to the client 105 that the request is invalid (step 520). If the replacement or modifying rights can be granted (“yes” branch of decision step 530) or if the subsequent rights transaction request 135 is not related to a modification or replacement of the rights (“no” branch of decision step 525), the rights transaction server authenticates the subsequent rights transaction request 135 (step 505) and determines if the subsequent rights transaction request is valid (step 510). If the subsequent rights transaction request is not valid (“no” branch from decision step 510), the rights transaction server transmits a message to the client 105 that the request is invalid (step 520). If the subsequent, rights transaction request is valid (“yes” branch from decision step 510), the rights transaction server determines if the subsequent rights transaction request 135 is a request to relinquish, replace, or modify the rights for the media object. If the subsequent rights transaction request 135 is a request to relinquish the rights (“relinquish” branch of decision step 512), the rights transaction server transmits an acknowledgement to the client 105. If the subsequent rights transaction request 135 is a request to replace the rights (“replace” branch of decision step 512), the rights transaction server transmits a replacement rights object to the client 105. If the subsequent rights transaction request 135 is a request to modify the rights (“modify” branch of decision step 512), the rights transaction server transmits a modifying rights object to the client 105.

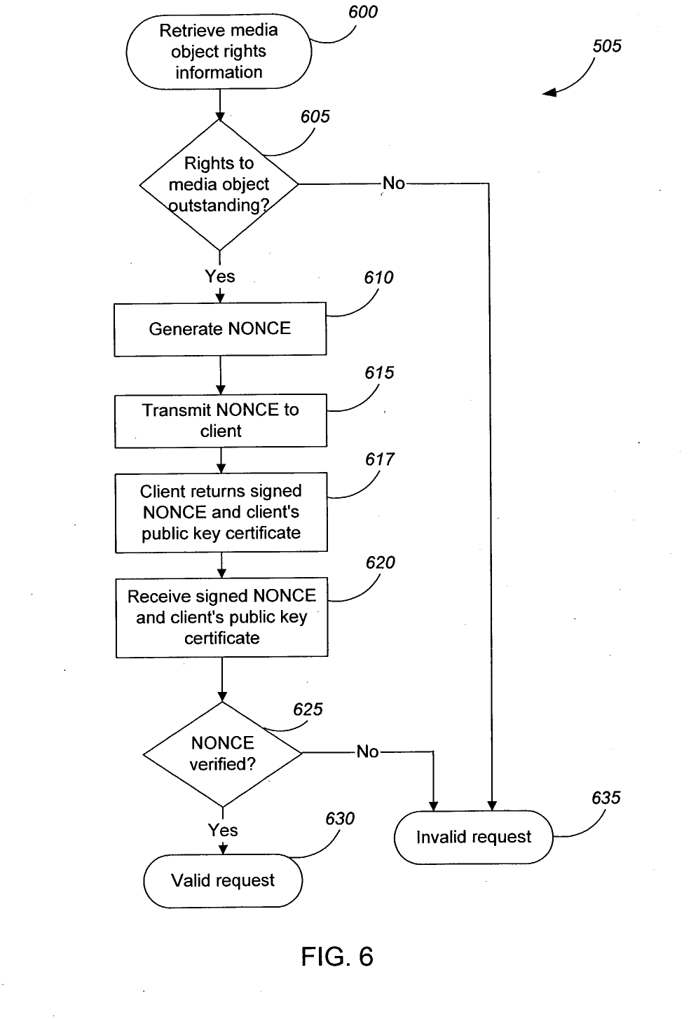

FIG. 6 is a flow diagram illustrating a method for authenticating the subsequent rights transaction request 135 (step 505, FIG. 5). Rights information for the media object associated with the request is retrieved (step 600) to determine if there are any outstanding rights to the media object that have not been returned (step 605). If there are no rights to the media object outstanding (“no” branch of decision step 605), the subsequent rights transaction request 135 is determined invalid and the method terminates (step 635). If there are rights to the media object outstanding (“yes” branch of decision step 605), a NONCE is generated (step 610) and transmitted to the client (step 615). The client signs the NONCE using a standard signature algorithm by first generating a message digest of the NONCE, and then encrypting the message digest with the client's private key. The client returns the signed NONCE and the client's public key certificate to an authentication server (step 617). The signed NONCE and the client's public key certificate can be returned to the rights transaction server or to any other server required by the authentication step (step 505, FIG. 5). The signed NONCE and the client's public key certificate are received (step 620), and the client's public key certificate is used to verify the signed NONCE (step 625). The verification in step 625 can include validating the client's public key certificate or certificate chain against a list of certificate issuers (certificate authentication). If the signed NONCE is verified (“yes” branch of decision step 625), the subsequent rights transaction request is determined to be valid (step 630). If the signed NONCE cannot be verified (“no” branch of decision step 625), the subsequent rights transaction request is determined to be invalid (step 635).

The NONCE can be any data that is known only to the authentication server. In one implementation, the NONCE is a random number. In another implementation, the NONCE is valid for a predetermined duration of time and the subsequent rights transaction request is determined to be invalid if the client does not return the signed NONCE within the predetermined duration of time.

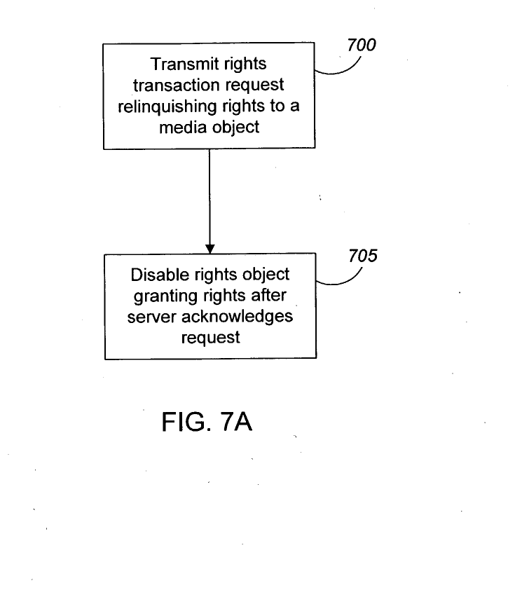

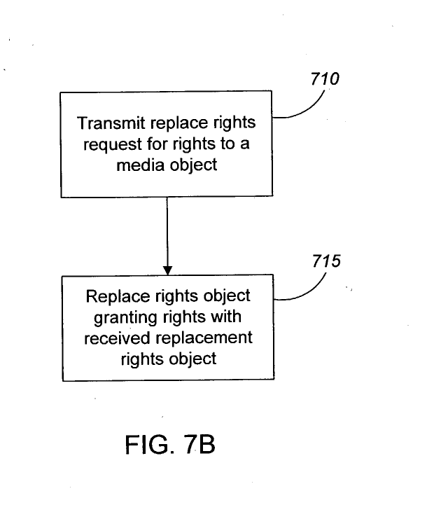

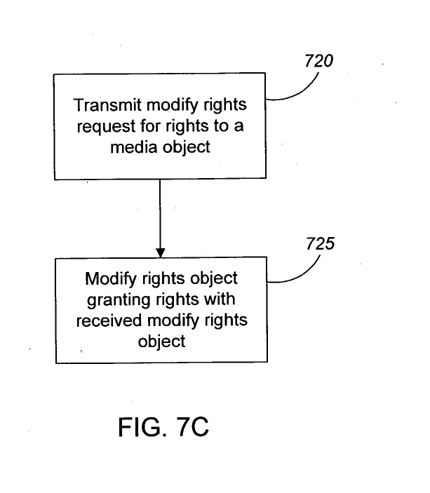

FIG. 7A illustrates a method of processing a subsequent rights transaction request (135, FIG. 1) relinquishing the rights at the client 105. The client transmits the subsequent rights transaction request 135 relinquishing the rights to a media object (step 700). In one implementation, the subsequent rights transaction request 135 is transmitted to a rights transaction server identified by the return address in the rights object (200, FIG. 2) granting the rights to the media object. The client disables the rights object 200 granting the rights to the media object after the rights transaction server acknowledges the subsequent rights transaction request 135 (step 705).

FIG. 7B illustrates a method of processing at the client 105 a subsequent rights transaction requesting replacement rights. The client transmits the replace rights request for rights to a media object (step 710). In one implementation, the replace rights transaction request is transmitted to a rights transaction server identified by the return address in the rights object (200, FIG. 2) granting the rights to the media object. If the replace rights request is validated by the rights transaction server, as discussed above, the client 105 receives a replacement rights object and replaces the rights object (200, FIG. 2) granting the rights to the media object with the received replacement rights object (step 715).

FIG. 7C illustrates a method of processing a subsequent rights transaction requesting modifying rights at the client 105. The client transmits the modify rights transaction request for rights to a media object (step 720). In one implementation, the modify rights request is transmitted to a rights transaction server identified by the return address in the rights object (200, FIG. 2) granting the rights to the media object. If the modify rights request is validated by the rights transaction server, as discussed above, the client 105 receives one or more modifying rights (e.g., in a modifying rights object), and modifies the rights object 200 granting the rights to the media object with the received modifying rights object (step 725).

Referring to FIG. 7A, FIG. 7B, and FIG. 7C, the specific operation requested by the subsequent rights transaction request (135, FIG. 1) (e.g., relinquish rights, replace rights, and/or modify rights) can be included in a rights message built into the return address, added on to the return address, or sent in a rights message transmitted to return address. In one implementation, the client can transmit the transaction identifier (220, FIG. 2) as part of the subsequent rights transaction request 135. In another implementation, the client transmits all or part of the original rights object 200 as part of the subsequent rights transaction request 135.

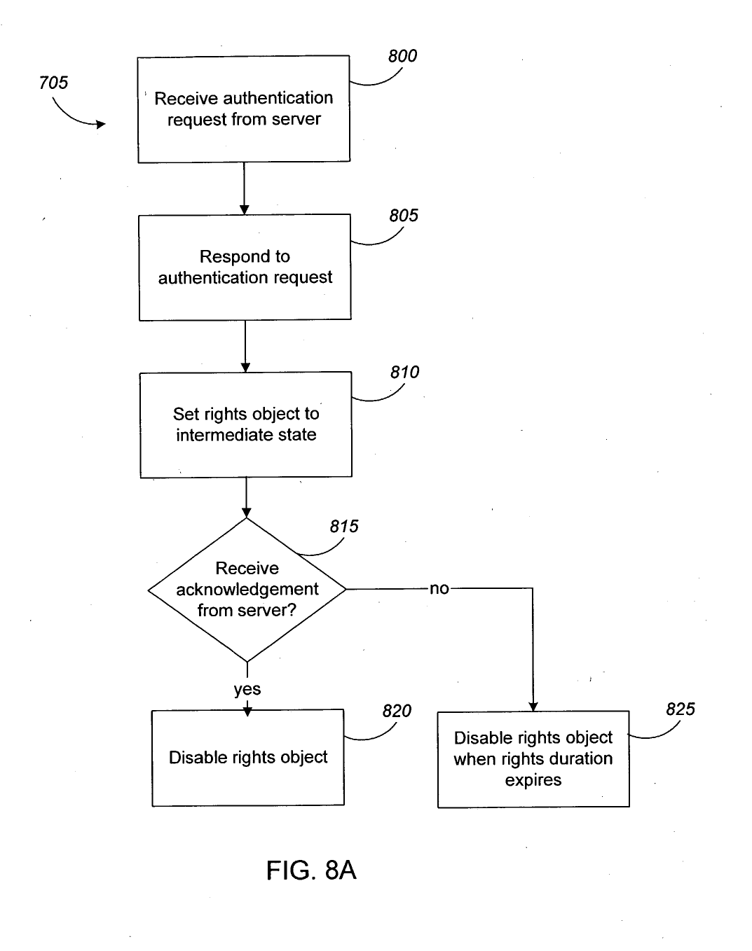

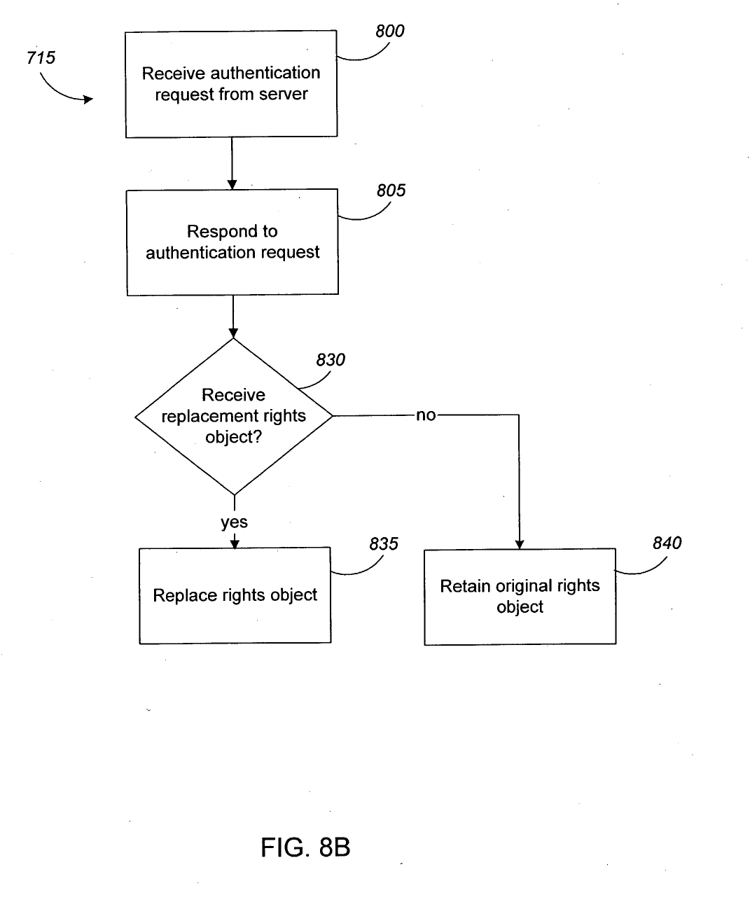

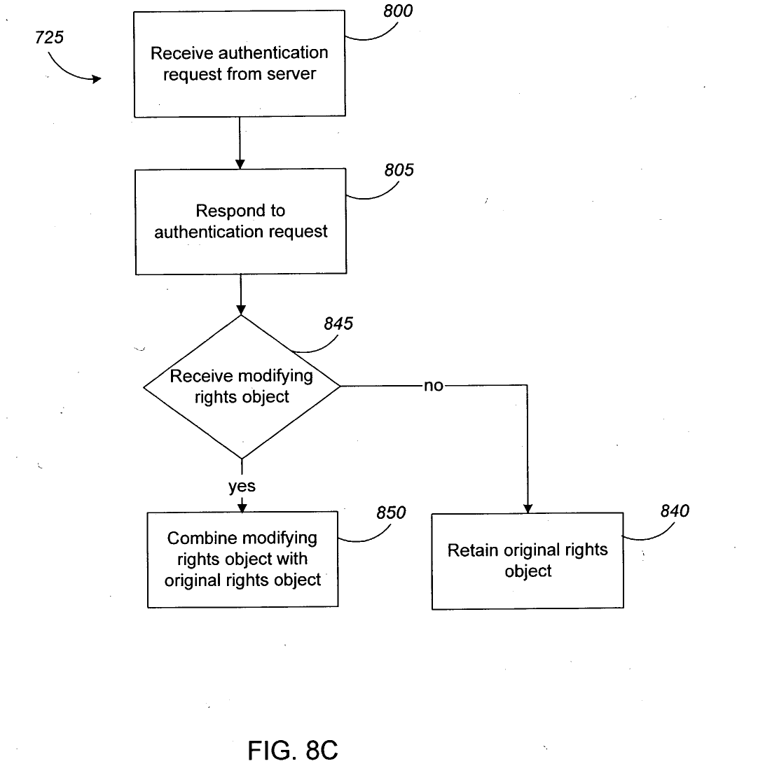

FIG. 8A illustrates a method for disabling a rights object (200, FIG. 2) granting one or more rights to a media object after the server acknowledges the subsequent rights transaction request (135, FIG. 1) relinquishing the rights (step 705, FIG. 7A). The client 105 receives an authentication request from rights transaction server processing the subsequent rights transaction request 135 (step 800). The client responds to the authentication request (step 805), and sets the rights object 200 to an intermediate state (step 810). If the client receives an acknowledgment from the rights transaction server (“yes” branch of decision step 815), the rights object 200 is disabled (step 820). If the client does not receive an acknowledgment from the rights transaction server (“no” branch of decision step 815), the rights object 200, set to the intermediate state, is disabled at the expiration of the associated loan duration 215. In one implementation, if the rights object 200 is in an intermediate state, the client 105 cannot use the associated rights 210 to the media object. In another implementation, the client 105 can use the rights object 200 in an intermediate state only to retry the relinquish rights transaction relinquishing the rights to the media object.

FIG. 8B illustrates a method for replacing a rights object with a replacement rights object (step 715, FIG. 7B). The client 105 receives an authentication request from the rights transaction server processing the subsequent rights transaction request 135 (step 800). The client 105 responds to the authentication request (step 805). If the client 105 receives a replacement rights object (“yes” branch of decision step 830), the client 105 stores the replacement rights object and discards the original rights object (step 835). If the client 105 does not receive a replacement rights object (“no” branch of decision step 830), the client retains the original rights object (step 840).

FIG. 8C illustrates a method for modifying a rights object with a modifying rights object (step 725, FIG. 7C). The client 105 receives an authentication request from the rights transaction server processing the subsequent rights transaction request 135 (step 800). The client 105 responds to the authentication request (step 805). If the client receives a modifying rights object (“yes” branch of decision, step 845), the client combines the modifying rights object with the original rights object (step 850). Techniques for modifying a set of initial rights according to a set of modifying rights are described in U.S. application Ser. No. ______, titled “Modifying Digital Rights,” to Jason Boyer, Lawrence MacLennan, and Robert Mathews, filed on Jun. 16, 2003, which is incorporated by reference herein. If the client does not receive a modifying rights object (“no” branch of decision, step 845), the client 105 retains the original rights object (step 840).

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or- more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results. The communication between the client and the media object server can use any messaging protocol. The communication is typically over HTTP networks, but it is not limited to HTTP networks. The messages sent using the protocol can be of any format that is known to both client and server

What is claimed is:

1. A computer implemented method, comprising:
executing a media object server by a processing system of a server device that implements media object server operations comprising:
delivering a rights object to a client, the rights object granting one or more first rights to a media object to the client, the rights object having an associated return address;
receiving a rights transaction request initiated by the client using the associated return address, the rights transaction request being a request to replace or to modify one or more of the first rights;
authenticating the rights transaction request;
if the rights transaction request is to replace one or more of the first rights, transmitting to the client a replacement rights object granting one or more second rights to the media object and otherwise, transmitting to the client one or more modifying rights that modify the one or more first rights granted by the rights object;
receiving a subsequent rights transaction request initiated by the client to relinquish one or more of the first rights to the media object, the subsequent rights transaction request originating from the client using the associated return address;
authenticating the subsequent rights transaction request; and
transmitting a response to the client acknowledging the subsequent rights transaction request.

2-8. (canceled)

9. The method of claim 1, wherein authenticating the subsequent rights transaction request includes:
determining whether the subsequent rights transaction request has been received during a time period defined by a rights duration associated with the one or more first rights.

10. The method of claim 1, wherein authenticating the rights transaction request includes:
if the rights transaction request is a replace rights request, determining whether the replace rights request can be granted; and
if the rights transaction request is a modify rights request, determining whether the modify rights request can be granted.

11. The method of claim 1, wherein authenticating the rights transaction request includes:
determining whether there is a rights fulfillment transaction associated with the rights transaction request.

12. The method of claim 1, wherein receiving the rights transaction request includes receiving the rights transaction request having an associated transaction identifier.

13. The method of claim 12, further comprising:
using the associated transaction identifier to identify a rights fulfillment transaction associated with the one or more first rights.

14. The method of claim 12, further comprising:
using the associated transaction identifier to identify the media object associated with the one or more first rights.

15. The method of claim 1, wherein authenticating the rights transaction request includes:
determining whether the one or more first rights are outstanding;
if the one or more first rights are outstanding, generating a NONCE and transmitting the NONCE to the client;
receiving a signed NONCE and a public key certificate from the client, the signed NONCE being signed using a private key of the client; and
determining the validity of the rights transaction request using the signed NONCE and the public key certificate.

16-32. (canceled)

33. A computer-readable storage media device comprising stored instructions that are executable and, responsive to execution of the instructions by a media object server, the media object server performs operations comprising to:
deliver a rights object to a client, the rights object granting one or more first rights to a media object to the client, the rights object having an associated return address;
receive a rights transaction request initiated by the client using the associated return address, the rights transaction request being a request to replace or to modify one or more of the first rights;
authenticate the rights transaction request;
if the rights transaction request is to replace one or more of the first rights, transmit to the client a replacement rights object granting one or more second rights to the media object and otherwise, transmit to the client one or more modifying rights that modify the one or more first rights granted by the rights object;
receive a subsequent rights transaction request initiated by the client to relinquish one or more of the first rights to the media object, the subsequent rights transaction request originating from the client using the associated return address;
authenticate the subsequent rights transaction request; and
transmit a response to the client acknowledging the subsequent rights transaction request.

34-40. (canceled)

41. A computer-readable storage media device as recited in claim 33, wherein to authenticate the subsequent rights transaction request, the instructions implement the media object server to determine whether the subsequent rights transaction request has been received during a time period defined by a rights duration associated with the one or more first rights.

42. A computer-readable storage media device as recited in claim 33, wherein to authenticate the rights transaction request, the instructions implement the media object server to:
if the rights transaction request is a replace rights request, determine whether the replace rights request can be granted; and
if the rights transaction request is a modify rights request, determine whether the modify rights request can be granted.

43. A computer-readable storage media device as recited in claim 33, wherein to authenticate the first rights transaction request, the instructions implement the media object server to determine whether there is a rights fulfillment transaction associated with the rights transaction request.

44. A computer-readable storage media device as recited in claim 33, wherein the instructions implement the media object server to receive the rights transaction request having an associated transaction identifier.

45. A computer-readable storage media device as recited in claim 44, wherein the instructions implement the media object server to use the associated transaction identifier to identify a rights fulfillment transaction associated with the one or more first rights.

46. The computer program product of claim 44, further comprising instructions operable to cause the data processing equipment to: A computer-readable storage media device as recited in claim 44, wherein the instructions implement the media object server to use the associated transaction identifier to identify the media object associated with the one or more first rights.

47. A computer-readable storage media device as recited in claim 33, wherein to authenticate the rights transaction request, the instructions implement the media object server to:
determine whether the one or more first rights are outstanding;
if the one or more first rights are outstanding, generate a NONCE and transmit the NONCE to the client;
receive a signed NONCE and a public key certificate from the client, the signed NONCE being signed using a private key of the client; and
determine the validity of the rights transaction request using the signed NONCE and the public key certificate.

48-62. (canceled)

63. A system comprising:
a server device that communicates a rights object having an associated return address to a client, the rights object granting one or more rights to a media object for the client;
a processing system to implement a media object server that is configured to:
receive a relinquish rights transaction request initiated by the client to relinquish one or more of the rights to the media object, the relinquish rights transaction request originating from the client that uses the associated return address;
authenticate the relinquish rights transaction request; and
communicate a response to the client acknowledging the relinquish rights transaction request.

64. (canceled)

65. The system of claim 63, wherein the media object server is configured to determine whether the relinquish rights transaction request has been received during a time period defined by a rights duration associated with the one or more rights.

66-71. (canceled)

72-75. (canceled)

76. The system of claim 63, wherein the media object server is configured to receive the relinquish rights transaction request as a client request to relinquish a subset of the one or more rights granted by the rights object.

77. The system of claim 63, wherein the media object server is configured to receive the relinquish rights transaction request as a client request to relinquish all of the rights granted by the rights object.

78. The method of claim 1, wherein the subsequent rights transaction request is received as a client request to relinquish a subset of the one or more first rights granted by the rights object.

79. The method of claim 1, wherein the subsequent rights transaction request is received as a client request to relinquish all of the rights granted by the rights object.

80. A computer-readable storage media device as recited in claim 33, wherein the subsequent rights transaction request is received as a client request to relinquish a subset of the one or more first rights granted by the rights object.

81. A computer-readable storage media device as recited in claim 33, wherein the subsequent rights transaction request is received as a client request to relinquish all of the rights granted by the rights object.

82. The system as recited in claim 63, wherein the media object server is configured to:
receive a modify rights transaction request from the client that uses the associated return address, the modify rights transaction request received to initiate modification of the one or more rights to the media object;
authenticate the modify rights transaction request; and
communicate modifying rights to the client responsive to authentication of the modify rights transaction request, the modifying rights granting one or more modified rights to the media object for the client.

83. The system as recited in claim 63, wherein the media object server is configured to:
receive a replace rights transaction request from the client that uses the associated return address, the replace rights transaction request received to initiate replacement of the one or more rights to the media object;
authenticate the replace rights transaction request; and
communicate a replacement rights object to the client responsive to authentication of the replace rights transaction request, the replacement rights object granting one or more replacement rights to the media object for the client.

84. The system as recited in claim 63, wherein the media object server is configured to receive a rights transaction request from the client that uses the associated return address, the rights transaction request received to initiate replacing or modifying one or more of the rights.

85. The system as recited in claim 84, wherein the media object server is configured to authenticate the rights transaction request that includes:
determine whether replacement rights can be granted if the rights transaction request is a replace rights request; and
determine whether modified rights can be granted if the rights transaction request is a modify rights request.

86. The system as recited in claim 84, wherein the media object server is configured to determine whether there is a rights fulfillment transaction associated with the rights transaction request.

87. The system as recited in claim 84, wherein the media object server is configured to receive the rights transaction request with an associated transaction identifier.

88. The system as recited in claim 87, wherein the media object server is configured to use the associated transaction identifier to identify a rights fulfillment transaction associated with the one or more rights to the media object.

89. The system of claim 87, wherein the media object server is configured to use the associated transaction identifier to identify the media object associated with the one or more rights.

90. The system as recited in claim 84, wherein the media object server is configured to authenticate the rights transaction request that includes:
generate a NONCE;
communicate the NONCE to the client;
receive a signed NONCE and a public key certificate from the client, the signed NONCE being signed using a private key of the client; and
determine the validity of the rights transaction request using the signed NONCE and the public key certificate.

91. A computer implemented method, comprising:
executing a media object server by a processing system of a server device that implements media object server operations comprising:
communicating a rights object having an associated return address to a client, the rights object granting one or more rights to a media object for the client;
receiving a relinquish rights transaction request initiated by the client to relinquish one or more of the rights to the media object, the relinquish rights transaction request originating from the client that uses the associated return address;
authenticating the relinquish rights transaction request; and
communicating a response to the client acknowledging the relinquish rights transaction request.

92. A computer implemented method as recited in claim 91, further comprising:
receiving a rights transaction request from the client that uses the associated return address, the rights transaction request received to replace or modify one or more of the rights;
authenticating the rights transaction request; and one of:
communicating a replacement rights object to the client responsive to the rights transaction request to replace the one or more rights, the replacement rights object granting one or more replacement rights to the media object for the client; or
communicating modifying rights to the client responsive to the rights transaction request to modify the one or more rights, the modifying rights granting one or more modified rights to the media object for the client.

93. A computer implemented method as recited in claim 91, further comprising:
receiving a modify rights transaction request from the client that uses the associated return address, the modify rights transaction request received to initiate modification of the one or more rights to the media object;
authenticating the modify rights transaction request; and
communicating modifying rights to the client responsive to authentication of the modify rights transaction request, the modifying rights granting one or more modified rights to the media object for the client.

94. A computer implemented method as recited in claim 91, further comprising:
receiving a replace rights transaction request from the client that uses the associated return address, the replace rights transaction request received to initiate replacement of the one or more rights to the media object;
authenticating the replace rights transaction request; and
communicating a replacement rights object to the client responsive to authentication of the replace rights transaction request, the replacement rights object granting one or more replacement rights to the media object for the client.
